(19) United States
(12) Patent Application Publication
(10) Pub. No.: US 2004/0115414 A1
(43) Pub. Date: Jun. 17, 2004

(54) Method for stiffening or reinforcing a member in a cost effective manner and a member which is made in accordance with the method

(76) Inventor: Joseph Wycech, Warren, MI (US)

Correspondence Address: John G. Chupa, Law Offices of John Chupa & Associates, P.C., 28535 Orchard Lake Rd., Ste. 50, Farmington Hills, MI, 48334, US

(21) Appl. No.: 10/099,572

(22) Filed: Mar. 15, 2002

(51) Int. Cl. B65B 1/00; B65C 1/00; B31B 1/60; B32B 31/00; B32B 3/26

(52) U.S. Cl. 428/304.4; 156/60

(57) ABSTRACT

A member (10) and a method for forming member (10). Member (10) includes a foam material (16) which is attached to the member (10) by the use of a layer of polyurea material. These layers cooperate to rigidize the member (10) and reduce the noise generation and transmission attributes of the member (10).

### FIELD OF THE INVENTION

The present invention generally relates to a method for stiffening or reinforcing a member in a cost effective manner and a member which is made in accordance with the method and more particularly, to a method for cost effectively creating a member which may be used within an assembly and which increases the overall strength and sturdiness of the member and the assembly while concomitantly improving the noise generation and/or noise transmission attributes of the assembly and improving the noise generation and/or noise transmission attributes of the member.

### BACKGROUND OF THE INVENTION

Assemblies, such as and without limitation an automobile and a dishwasher, are created by the cooperative interconnection of various members (hereinafter the various interconnected members which cooperatively form an assembly are sometimes collectively referred to as “constituent elements” or “constituent elements of the assembly”). Further, it should be understood that the term “member”, as used in this description, means any tangible item which may be used, either singularly or in cooperative combination with other members or other tangible items, to form an assembly. As such, the term “member” is to be construed in the broadest manner possible and, as is evident from the description below, the principles of the present invention are advantageously applicable to any tangible item.

Further, the overall structural integrity of an assembly is dependent upon the structural integrity of each of these cooperatively interconnected members which form the assembly and the various operational characteristics or attributes of the completed assembly, such as and without limitation, the amount of noise which is emitted by the assembly as it is operated, is also dependent upon the various attributes and characteristics of the constituent elements that form the assembly.

It is generally considered to be a desirable objective to create an assembly which is relatively sturdy or strong and which generates relative-low amounts of noise as it is operated. While these characteristics are highly desirable, the achievement of this objective is relatively costly, typically requiring the use of relatively heavy and costly constituent elements. Moreover, not only do these relatively heavy constituent elements increase the overall cost of the produced assembly, they typically and undesirably increase the overall amount of energy which is utilized by the assembly (i.e., increasing the weight of the hood and other constituent elements of an automobile typically increases the overall amount of fuel which is used by the automobile as the automobile is operated).

It is therefore desirable to provide a method for increasing the stiffness or the strength of a member in a cost effective manner and without appreciably increasing the weight of the member, effective to allow the overall created assembly to have desirable operating attributes and characteristics. It is also desirable to provide a cost effective method for reducing the noise generated or transmitted by an assembly and for reducing the amount by which a member vibrates. The present invention achieves these and many other objectives in a new and novel fashion which is further set forth below.

### SUMMARY OF THE INVENTION

It is a first non-limiting advantage of the present invention to provide a method for stiffening or strengthening, and “rigidizing” a member in a manner which overcomes the various previously delineated disadvantages of prior member strengthening or stiffening methods.

It is a second non-limiting advantage of the present invention to provide a method for reducing the noise produced by an assembly in a manner which overcomes the various previously delineated disadvantages of prior methods.

It is a third non-limiting advantage of the present invention to provide an article or member which is produced by the methodology of the invention.

It is a fourth non-limiting advantage of the present invention to provide a method for stiffening a member. Particularly, the method includes the steps of depositing flexible elastic material on at least a portion of the member; providing a filler material; placing the filler material onto the applied flexible elastic material; and depositing flexible elastic material onto the filler material.

It is a fifth non-limiting advantage of the present invention to provide a method for stiffening a member. Particularly, the method includes the steps of providing foam material; depositing flexible elastic material onto the foam material; and coupling at least one surface of the member to the deposited flexible elastic material.

It is a sixth non-limiting advantage of the present invention to provide an article which is made by the process of providing a first material; forming the first material into a certain shape; depositing flexible elastic material onto at least one surface of first material; providing foam material; placing the foam material onto the deposited flexible elastic material; and depositing flexible elastic material onto the foam material.

It is a seventh non-limiting advantage of the present invention to provide an article which is made by the process of providing a first material; forming the first material into a certain shape; providing foam material; applying a flexible elastic material onto the foam material; and coupling the applied flexible elastic material to the first material.

It is an eighth non-limiting advantage of the present invention to provide a member comprising a first outer portion which has a certain predetermined shape and which has an inner surface; a first layer of a polyurea composition which substantially covers the entire inner surface; a layer of foam material having a first outer surface and a second inner surface which substantially covers and is coupled to the first layer of the polyurea composition; and a second layer of the polyurea composition which resides upon substantially the entire first outer surface of the foam material.

These and other features and advantages of the present invention will become apparent from a reading of the following detailed description of the preferred embodiment of the invention and by reference to the following drawings.

### BRIEF DESCRIPTION OF THE DRAWINGS

FIG. 1 is a perspective partial view of an assembly including a member which is made in accordance with the teachings of the preferred embodiment of the invention;

FIG. 2 is a perspective view of the member which is shown in FIG. 1;

FIG. 3 is a perspective view of a member which is made in accordance with the teachings of an alternate embodiment of the invention;

FIG. 4 is a partial side sectional view of the member which is shown in FIG. 2;

FIG. 5 is a partial side sectional view a member which is made in accordance with the teachings of yet another alternate embodiment of the invention;

FIG. 6 are diagrammatical views of a method for stiffening a member according to the teachings of a first embodiment of the invention;

FIG. 7 are diagrammatical views of a method for stiffening a member according to the teachings of a second embodiment of the invention;

FIG. 8 is a perspective partial cutaway view of a vehicular hood which is made in accordance with the teachings of the invention;

FIG. 9 is a view of the underside of the vehicular hood which is shown in FIG. 8; and

FIG. 10 is a partial side sectional view of the vehicular hood which is shown in FIGS. 8 and 9.

### DETAILED DESCRIPTION OF THE PREFERRED EMBODIMENT OF THE INVENTION

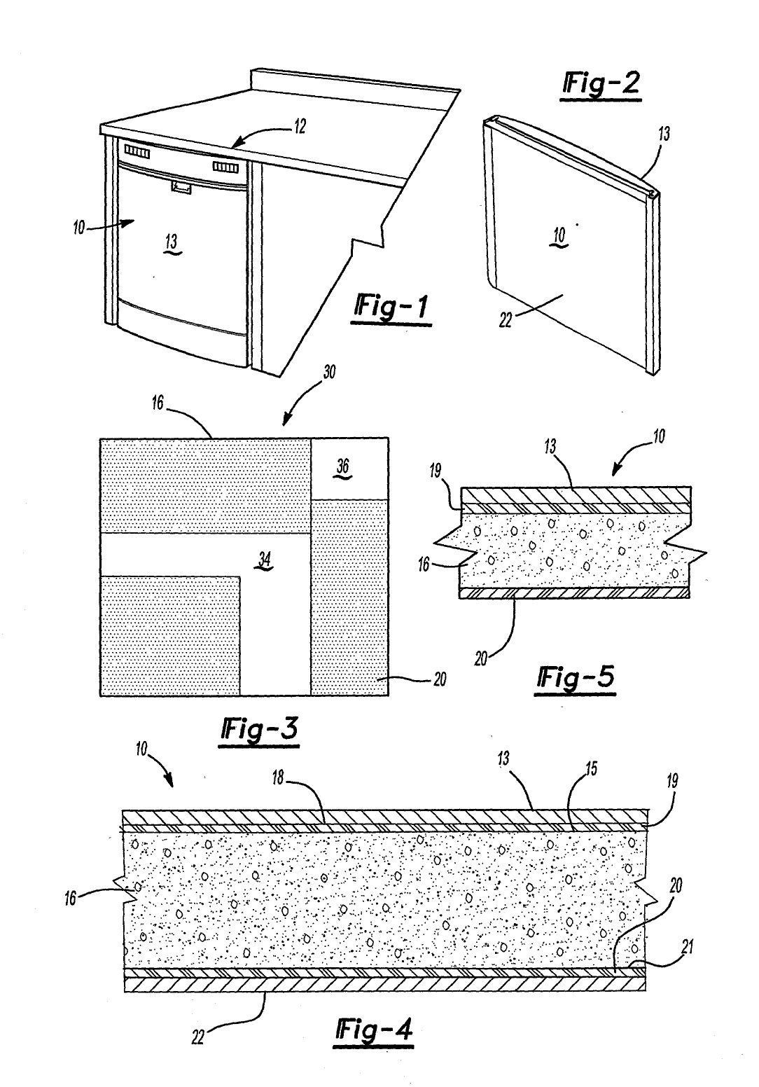

Referring now to FIGS. 1, 2, and 4 there is shown a dishwasher facia or front member 10 which is made in accordance with the teachings of the preferred embodiment of the invention and which is shown in an operative assembled relation with a dishwasher 12. Particularly, front facia member 10 is adapted to be used with any type of dishwasher and nothing in this description is meant to limit the use of frontal member 10 to a particular type of dishwasher, such as that which is shown in the various FIGS. 1, 2, and 4. Further, as is evident from the following discussion, it should be apparent to those of ordinary skill in the art that the principles of the various inventions which are included in this Application are not limited to use with a dishwasher or a dishwasher facia member. Rather, these principles are applicable to substantially any tangible item or member and nothing in this Application is meant to limit the general applicability of the various described inventions to a wide range of tangible items. Hence, dishwasher 12 and facia member 10 are used for the sole purpose of illustrating the general principles of some of the inventive concepts of the inventions and are not limiting.

Particularly, dishwasher frontal member 10 may be formed in any desired shape and size and, in one non-limiting embodiment, generally comprises a generally rectangular shape and is generally formed from conventional steel, aluminum, or other commercially available material and has an exterior surface 13 and an interior surface 18. Particularly, it is generally desirable to manufacture the dishwasher frontal member 10 by the use of a relatively thin material (e.g., the frontal facia member is a “thin walled member”) in order to reduce the cost of producing the member 10 and the dishwasher 12; reduce the overall weight of the dishwasher 12, thereby reducing shipping costs, effective to allow the dishwasher to be easily transported; and reduce the overall energy consumption of the dishwasher 12. However, while the use of a relatively thin walled member 10 does provide the previously delineated benefits, it is easily deformable or susceptible to damage, especially as the member 10 is installed onto the dishwasher 12, and is easily vibrated and easily transmits the noise which is generated by the dishwasher assembly 12 to the surrounding area or the ambient environment in which the dishwasher 12 is disposed. Hence, the use of a thin walled facia member 10 undesirably increases the noise associated with the dishwasher 12 and undesirably transmits the generated noise to those in close proximity to the dishwasher 12. The present invention may be used to reduce or eliminate the undesired attributes or characteristics of such a thin walled facia member in a manner which does not appreciably increase the production costs of the dishwasher 12 and which, by way of example and without limitations, “rigidizes” and strengthens the member 10.

Particularly, the dishwasher facia member 12 includes a foam filler or foam “block” portion 16 which has a first surface 15 which is coupled to the inner surface 18 of the frontal member 10 by the use of a first layer 19 of a highly elastic elongated material such as but not limited to a polyurea or a polyurea composition. Foam filler portion 16 further has a second surface 21 which is substantially covered with a second layer 20 of the highly elastic elongated material which, as earlier stated, comprises, by way of example and without limitation a polyurea or a polyurea composition material. Particularly, in one non-limiting embodiment of the invention, the foam filler portion 16 is substantially the same size and shape as the inner surface 18 (and substantially the same size and the same shape as the member 10) and has a thickness which is substantially larger than the thickness of the facia member 12 (e.g., larger by a factor of about three to about six). As is further best shown in FIG. 4, the dishwasher facia member 10 further includes an inner panel 22 which is coupled to the foam filler material 16 by the use of the second layer 20 of polyurea material.

In one non-limiting embodiment of the invention, the foam filler portion 16 comprises commercially available styrofoam material and the polyurea material comprises commercially available material which is referred to as “Quantumshield” which is available from The Aristo-Cote Company which is located at 111 Shafer Drive, Romeo, Mich. 48065, although other materials and compositions may be utilized. Hence, the foam filler portion 16 and the employed polyurea composition are relatively cost effective and are readily commercially available.

Moreover, Applicant has achieved unexpected results by combining the previously delineated layers of polyurea material 19, 20 and the foam material 16 in the foregoing manner. That is, the measured resistance to deformation of the dishwasher facia member 10 increases about five hundred percent relative to a conventional dishwasher facia member and the susceptibility to vibration decreases about five hundred percent relative to a conventional dishwasher facia member by combining the utilized polyurea composition with the foam material 16 in the foregoing manner. Hence, the combination of the polyurea material layers 19, 20 and the foam filler material 16 provides these unexpected benefits in a new and novel fashion. In one non-limiting embodiment of the invention, the entire surface 15 and the entire surface 21 receive the polyurea material, although other amounts may be used. In another non-limiting embodiment of the invention, layer 20 is not applied to surface 21 and inner panel 22 is coupled directly to or integrally formed with the foam material 16.

In yet another non-limiting embodiment of the invention, as is best shown in FIG. 5, the dishwasher facia member 10 does not include an inner panel 22 and this alternate embodiment still provides substantially the same foregoing benefits over a conventional dishwasher facia member. In this alternative embodiment, the layer of polyurea material 20 may be placed upon surface 21 or material 20 may be omitted (i.e., the foam filler material 16 is left “bare”).

As is best shown in FIG. 3, a dishwasher facia panel 30 may be made in accordance with the teachings of yet another alternate embodiment of the invention. Particularly, in this alternate embodiment of the invention, a passage or indentation, such as and without limitation, passage 34 may be formed within the foam 16 in order to provide support for electrical conduits and/or other electrical devices or busses which communicate power to the dishwasher 12, and another indentation or pocket 36 may be formed within the foam member 16, effective to provide a soap dispenser support or cavity. In this manner, these “preformed” passages, channels, and pockets may further reduce the cost of producing the dishwasher 12 or other assembly and allow for efficient production. Hooks or other members may also be placed within the foam 16. Polyurea material may be placed upon these portions 34, 36, and/or upon the foam 16. Alternatively, no polyurea material may be used upon the foam 16 except the material needed to coupled the foam 16 to the surface 18 of the member 10.

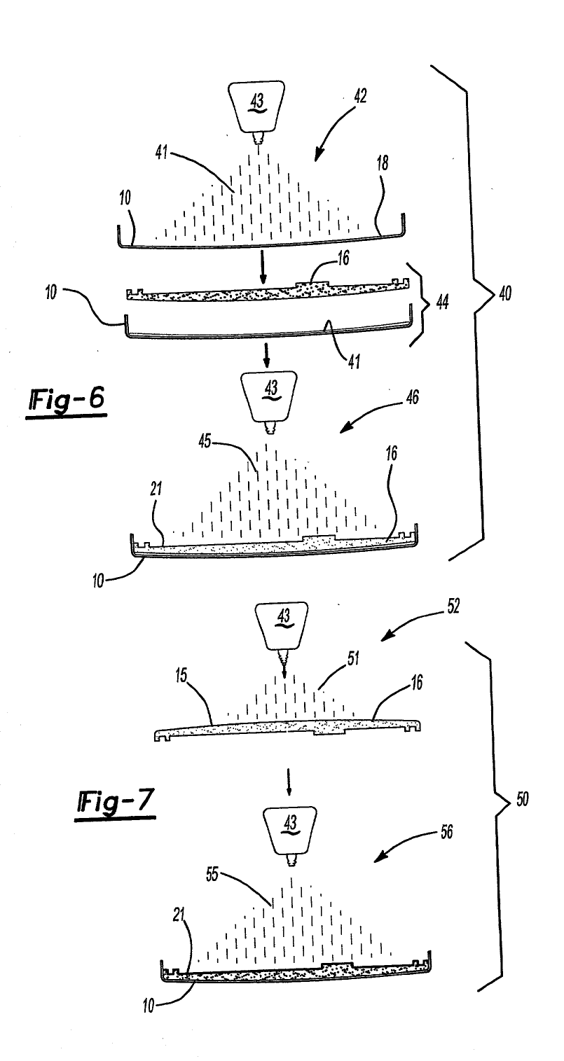

One method 40 to create the dishwasher facia member 12 is shown in FIG. 6. Particularly, the method 40 begins with an initial step 42 in which the polyurea composition material 41 is applied to (e.g., sprayed upon) the inner surface 18 of the member 10 by sprayer 43. In step 44, which follows step 42 the applied material 41 on surface 18 begins to harden or becomes “tacky” and the foam material 16 is then placed upon the previously applied polyurea material 41 thereby causing the foam material 16 to adhere to the inner surface 18 of the member 10. Step 46 follows step 44 and, in this step 46, additional polyurea material 45 is sprayed onto the outer surface 21 of the foam material 16. An inner panel (such as panel 22) may be applied to this deposited polyurea material 45 after it has become tacky. In one non-limiting embodiment of the invention, the thickness of the polyurea material 41 which is applied to the inner surface 18 is substantially similar to the thickness of the polyurea material 45 which is applied to the surface 21, although other thickness arrangements may be utilized.

A second method 50 to create the dishwasher facia member 10 is shown in FIG. 7 and begins with an initial step 52 in which the surface 15 of the foam material or member 16 receives and is substantially covered by a layer of polyurea material 51. Step 56 follows step 52 and, in this step 56, the polyurea material 51 covered surface 15 is then coupled to the inner surface 18 of the member 10, thereby causing the foam member 16 to adhere to the member 0.10. Additional polyurea material 55 may be applied to the surface 21 and an inner panel 22 may also be utilized and selectively coupled to the surface 21.

It should be appreciated that many diverse types of members may be strengthened and concomitantly have their noise and vibration transmission and generation characteristics greatly enhanced by the previously delineated methodology of the preferred embodiment of the invention. By way of further example and without limitation, a vehicular hood may be produced in accordance with the teachings of the invention. That is, as shown in FIGS. 8-10, vehicular hood 60 may be of substantially any desired shape and size and includes an outer normally visible surface 62 and an inner surface 64 upon which a layer of polyurea material 66 resides. Particularly, the layer of polyurea material 66 couples the inner surface 64 to a foam material 16 which is substantially the same size and the same shape as the vehicular hood 60. A second layer 70 of polyurea material may cooperate with the first layer 66 of polyurea material to encapsulate foam material 16 (i.e., layer 70 is attached to the exposed surface of the material 16 which is distant from the surface 64 of the hood 60).

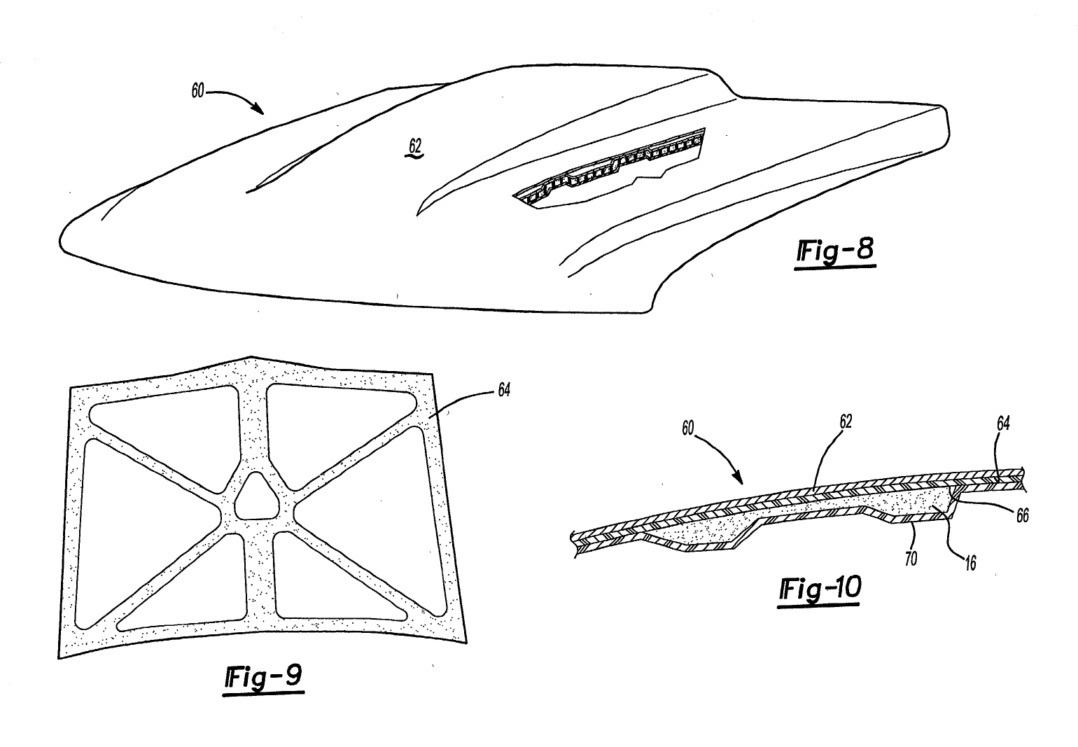

Particularly, the strength of a vehicular hood is enhanced by about five hundred percent by adhering the foam material 16 to the hood 60 in the previously delineated manner. The vibrational generation attribute of the vehicular hood 60 decreases by about three hundred percent by adhering the foam material 16 to the hood in the previously delineated manner. As shown in FIG. 9, it should also be appropriated that the foam material 16 may be of any desired size and shape which strengthens hood 60 while reducing the vibration generation characteristics of hood 60.

It is to be understood that the invention is not limited to the exact construction and methodology which has been delineated above, but is meant to encompass all equivalents of such a construction and methodology to the fullest and broadest extent allowable under the law. For example and without limitation, filler material 16 disclosed in this Application may be composed of substantially any suitable commercial material, such as polyvinyl chloride, corrugated paper, polyethylene, or EVA.

What is claimed is:

1) A method for stiffening a member comprising the steps of:
depositing a first amount of flexible elastic material on at least a portion of said member;
providing a filler material;
placing said filler material onto said applied first amount of flexible elastic material; and
depositing a second amount of flexible elastic material onto said filler material.

2) The method of claim 1 wherein said filler material comprises styrofoam.

3) The method of claim 2 wherein said first and said second flexible elastic material comprises a polyurea composition.

4) The method of claim 3 wherein said step of depositing a first amount of flexible elastic material onto at least a portion of said member comprises the step of spraying said first amount of flexible elastic material onto said member.

5) The method of claim 4 wherein said step of depositing said first amount of flexible elastic material onto at least a portion of said member comprises the step of spraying an entire surface of said member with said flexible elastic material.

6) The method of claim 5 wherein said member has a certain first thickness and wherein said styrofoam has a second thickness which is substantially larger than said first thickness.

7) The method of claim 6 wherein said deposited first amount of flexible elastic material has a certain third thickness which is substantially less than said certain first thickness and wherein said deposited second amount of flexible elastic material has a fourth thickness which is substantially less than said certain first thickness.

8) A method for stiffening a member comprising the steps of:
providing a first material;
depositing flexible elastic material onto said first material; and
placing said deposited flexible elastic material onto at least one surface of said member, thereby coupling said at least one surface of said member to said deposited flexible elastic material.

9) The method of claim 8 wherein said flexible elastic material comprises polyurea composition.

10) The method of claim 9 wherein said first material comprises styrofoam.

11) The method of claim 10 wherein said member has a certain first thickness and wherein said styrofoam has a certain second thickness which is substantially larger than said first thickness.

12) The method of claim 11 wherein said polyurea composition applied to said first material entirely covers said at least one surface of said member.

13) The method of claim 12 wherein said polyurea composition is sprayed onto said first material.

14) The method of claim 13 wherein said deposited polyurea composition has a certain third thickness which is substantially less than said first thickness of said member.

15) A member which is made by the process of:
providing a first material;
forming said first material into a certain shape;
depositing flexible elastic material onto at least one surface of said first material;
providing foam material having a first and second surface, wherein said first and second surfaces are oppositely facing;
adhering said foam material to said deposited flexible elastic material by placing said first surface of said foam material onto said deposited flexible elastic material; and
depositing flexible elastic material onto said second surface of said foam material.

16) The member of claim 15 wherein said foam material comprises styrofoam.

17) The member of claim 16 wherein said flexible elastic material comprises a polyurea composition.

18) The member of claim 17 wherein said polyurea composition is deposited upon the entire at least one surface of said first material and wherein said polyurea composition is deposited upon the entire second surface of said foam material.

19) The member of claim 17 wherein said polyurea composition is sprayed onto said at least one surface of said first material in a manner which entirely covers said at least one surface of said first material and wherein said polyurea composition is sprayed onto the entire second surface of said foam material in a manner which entirely covers said second surface of said foam material.

20) The member of claim 19 wherein said polyurea composition which is sprayed onto said entire at least one surface of said first material has a first thickness and wherein said polyurea composition which is sprayed onto said entire second surface of said foam material has a thickness which is substantially similar to said first thickness.

21) A member which is made by the process of:
providing a first relatively thin material;
forming said first relatively thin material into a certain shape;
providing foam;
applying a flexible elastic material onto a first surface of said foam;
coupling said applied flexible elastic material which is resident upon said first surface of said foam to said first relatively thin material, thereby coupling said foam to said first relatively thin material.

22) The member of claim 21 wherein said foam comprises styrofoam.

23) The member of claim 22 wherein said flexible elastic material comprises a polyurea composition.

24) The member of claim 22 wherein said flexible elastic material is applied to the entire surface of said first relatively thin surface of said foam material.

25) The member of claim 22 wherein said flexible elastic material is sprayed onto said first surface of said foam material.

26) A member comprising a first outer portion which has a certain predetermined shape and which has an inner surface; a first layer of a polyurea composition which substantially covers said entire inner surface; a layer of filler material having a first outer surface and a second inner surface, wherein said second inner surface substantially covers and is coupled to said first layer of said polyurea composition; and a second layer of said polyurea composition which resides upon substantially the entire first outer surface of said filler material.

27) The member of claim 26 wherein at least one indentation is formed within said first outer surface of said layer of said filler material.

28) The member of claim 27 wherein said at least one indentation comprises a channel.

29) The member of claim 26 wherein said filler material comprises styrofoam.

30) The member of claim 26 wherein said first layer of said polyurea composition has a first thickness and wherein said layer of said filler material has a second thickness which is substantially larger than said first thickness.

31) The member of claim 26 wherein said filler material comprises corrugated paper.

32) The member of claim 26 wherein said filler material comprises polyvinyl chloride.

33) The member of claim 26 wherein said filler material comprises polyethylene.
